(19) United States
(12) Patent Application Publication
(10) Pub. No.: US 2025/0237984 A1
(43) Pub. Date: Jul. 24, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Kenji SAWAI, Kanagawa (JP)

(73) Assignee: FUJIFILM Business Innovation Corp., Tokyo (JP)

(21) Appl. No.: 18/771,390

(22) Filed: Jul. 12, 2024

(30) Foreign Application Priority Data
Jan. 22, 2024 (JP) 2024-007446

(51) Int. Cl. G03G 15/00

(52) U.S. Cl. CPC G03G 15/5058

(57) ABSTRACT

An information processing system includes a processor configured to: when an image quality abnormality appears in a test chart generated under a normal image forming condition along a sheet feed direction at time of printing of the test chart, acquire the test chart generated under the normal image forming condition as a reference image; acquire, as a different image forming condition image, a test chart generated under an image forming condition which is different from the normal image forming condition and is for allowing a user to determine an image forming process causing the image quality abnormality; cut out, from the reference image, an image that includes at least a part of an appearance portion of the image quality abnormality and has a predetermined width in the sheet feed direction; cut out, from the different image forming condition image, an image having a predetermined width in the sheet feed direction; and cause the images cut out from the reference image and the different image forming condition image to be arranged and displayed on one screen with positions of the images in a direction orthogonal to the sheet feed direction being aligned.

### CROSS-REFERENCE TO RELATED APPLICATIONS

This application is based on and claims priority under 35 USC 119 from Japanese Patent Application No. 2024-007446 filed Jan. 22, 2024.

### BACKGROUND

### (i) Technical Field

The present disclosure relates to an information processing system and a non-transitory computer readable medium.

### (ii) Related Art

An image forming apparatus such as a printer normally prints a test chart on a paper medium or the like through image forming processes, such as charging, exposure, development, transfer, and fixing. The image forming apparatus acquires an electronic document via a network or reads a document with a scanner to form a document image serving as original data for printing.

In an image forming apparatus, an image quality abnormality such as a streak may appear on a printed sheet surface due to abnormality, aging degradation, or the like of a member used for image forming, such as a charging roller or a magnet roller. In this case, the image quality abnormality is removed during maintenance work for the image forming apparatus by performing maintenance on the member causing the appearance of the image quality abnormality, among the members constituting the image forming apparatus.

In recent years, techniques have been available for determining an image forming process that is the cause of the appearance of an image quality abnormality. For example, in Japanese Unexamined Patent Application Publication No. 7-168484, by using a combination of a plurality of test charts (hereinafter, referred to as “bias development images”) generated according to image forming conditions different from those during normal image forming, it is possible to check under which image forming conditions a streak appears or disappears at the time of image forming. Once the image forming process causing the occurrence of the streak is identified by a user, maintenance staff performs work on a member that operates in the identified image forming process as a maintenance target.

Meanwhile, there is an image forming apparatus having a function to allow a user to confirm which image forming process has a problem by reading test charts printed under varying image forming conditions and displaying read images on a screen. In this image forming apparatus, if an image quality abnormality is detected in a test chart printed under a normal image forming condition, bias development images, which are test charts printed under image forming conditions in which functions of some of the image forming processes are not used, are printed and read by maintenance staff using a reading unit, and thus the images can be displayed on the screen. By referring to the plurality of bias development images displayed on the screen, the maintenance staff can confirm the presence or absence of an image quality abnormality and the appearance position thereof in each bias development image, and thus determines the image forming process that is the cause of the appearance of the streak.

Examples of the related art include Japanese Unexamined Patent Application Publication No. 2007-116546 and Japanese Unexamined Patent Application Publication No. 6-348803.

### SUMMARY

However, when the plurality of test charts are arranged and displayed on one screen, the test charts may be displayed in a reduced size due to the screen size. When the plurality of test charts are displayed in a reduced size, visual recognition of the image quality abnormality may become difficult. In particular, it becomes difficult to find an image quality abnormality such as a streak that appears on a test chart along the sheet feed direction at the time of printing of the document.

Aspects of non-limiting embodiments of the present disclosure relate to, when an image quality abnormality appears on a test chart along the sheet feed direction at the time of printing of a document, displaying an appearance portion of the image quality abnormality on the test chart with high visibility compared to when the test chart is displayed in a reduced size.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including: a processor configured to: when an image quality abnormality appears in a test chart generated under a normal image forming condition along a sheet feed direction at time of printing of the test chart, acquire the test chart generated under the normal image forming condition as a reference image; acquire, as a different image forming condition image, a test chart generated under an image forming condition which is different from the normal image forming condition and is for allowing a user to determine an image forming process causing the image quality abnormality; cut out, from the reference image, an image that includes at least a part of an appearance portion of the image quality abnormality and has a predetermined width in the sheet feed direction; cut out, from the different image forming condition image, an image having a predetermined width in the sheet feed direction; and cause the images cut out from the reference image and the different image forming condition image to be arranged and displayed on one screen with positions of the images in a direction orthogonal to the sheet feed direction being aligned.

### BRIEF DESCRIPTION OF THE DRAWINGS

Exemplary embodiments of the present disclosure will be described in detail based on the following figures, wherein:

FIG. 1 is a hardware configuration diagram of an image forming apparatus according to a first exemplary embodiment;

FIG. 2 is a block configuration diagram of the image forming apparatus according to the first exemplary embodiment;

FIG. 3 illustrates image forming conditions applied to test charts in the first exemplary embodiment;

FIG. 4A illustrates examples of test charts to be displayed, FIG. 4B illustrates an example of a screen display in which the test charts are displayed in a reduced size, and FIG. 4C illustrates an example of a screen display of the test charts in the first exemplary embodiment;

FIG. 5 illustrates another example of the screen display of the test charts in the first exemplary embodiment;

FIG. 6A illustrates examples of the test charts to be displayed, and FIG. 6B illustrates an example of a screen display of the test charts; and

FIG. 7A illustrates examples of the test chart to be displayed, and FIG. 7B illustrates an example of a screen display of the test charts in a second exemplary embodiment.

### DETAILED DESCRIPTION

Hereinafter, preferred exemplary embodiments of the present disclosure will be described with reference to the drawings.

### First Exemplary Embodiment

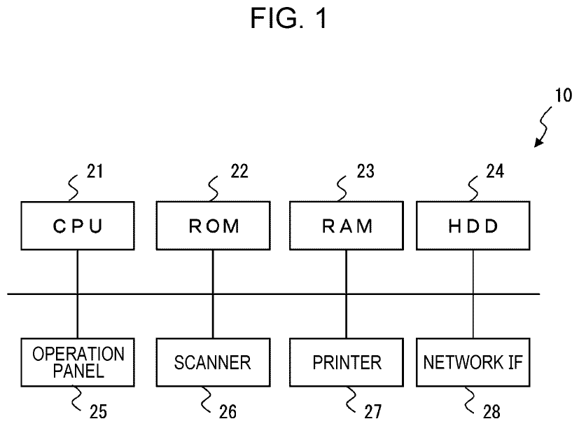

FIG. 1 is a hardware configuration diagram of an image forming apparatus 10 according to the present exemplary embodiment. The image forming apparatus 10 is a multifunction peripheral having various functions such as a print function, a copy function, and a scanner function, and is an apparatus incorporating a computer. The image forming apparatus 10 according to the present exemplary embodiment can be implemented with an existing general-purpose hardware configuration. That is, the image forming apparatus 10 incorporates a computer including at least a central processing unit (CPU) 21, a read-only memory (ROM) 22, a random access memory (RAM) 23, and a hard disk drive (HDD) 24. The image forming apparatus 10 further includes: an operation panel 25 as a user interface that functions as a display unit for displaying information and an input unit for allowing a user to input information; a scanner 26 that reads a document set on a document table and stores resultant electronic data in the HDD 24 or the like; a printer 27 that prints a test chart on an output sheet; and a network interface (IF) 28 as a communication unit.

As described later, in the present exemplary embodiment, images cut out from a plurality of images generated by reading what is printed according to designated image forming conditions by the reading unit are arranged and displayed on one screen. The operation panel 25 is used as the display unit to display the images in the arranged manner. Of course, the display unit is not necessarily limited to the operation panel 25, and a dedicated display device may be separately provided for the image forming apparatus 10, or a display unit included in an information processing apparatus such as a personal computer (PC) connected to the image forming apparatus 10 via a network may be used.

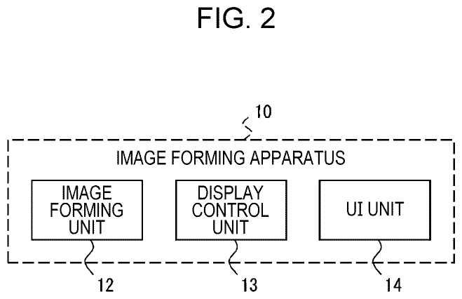

FIG. 2 is a block configuration diagram of the image forming apparatus 10 according to the present exemplary embodiment. The image forming apparatus 10 according to the present exemplary embodiment includes an image forming unit 12, a display control unit 13, and a user interface (UI) unit 14. Constituent elements which are not used in the description of the present exemplary embodiment are omitted from the drawings.

The image forming unit 12 forms a test chart in accordance with a predetermined image forming process. The test chart is printed by the printer 27. The printed test chart is read and displayed on the operation panel 25. The display control unit 13 performs display control for an image in the user interface unit 14. The user interface unit 14, which is implemented by the operation panel 25, receives a user operation, and displays an image under the display control by the display control unit 13.

Each of the constituent elements 12 to 14 in the image forming apparatus 10 is implemented by a cooperative operation of the computer forming the image forming apparatus 10 and a program run by the CPU 21 mounted in the computer.

The program used in the present exemplary embodiment may be provided not only by the communication unit but also by being stored in a computer-readable recording medium, such as a compact disc read-only memory (CD-ROM) or a Universal Serial Bus (USB) memory. The program provided from the communication unit or the recording media is installed in the computer, and the CPU 21 of the computer sequentially executes the program to implement various kinds of processing.

While an “information processing system” according to the present exemplary embodiment is described as being composed of the single image forming apparatus 10 by way of an example, the information processing system may be composed of a plurality of apparatuses, such as the image forming apparatus 10 and an information processing apparatus, such as a PC, so that, for example, image display can be performed by the information processing apparatus as described above.

The image forming unit 12 forms a test chart in accordance with predetermined image forming processes. These predetermined image forming processes generally include the processes of charging, exposure, and development, and the test chart is formed through these image forming processes. More specifically, in an image forming process called “charging”, a charger including a charging roller is caused to exert a charging function to charge a photosensitive member. In an image forming process called “exposure,” an exposure device including a laser or the like is caused to exert an exposure function to lower the potential for a to-be-printed part of a document on the surface of the charged photosensitive member. In an image forming process called “development”, a developing device including a magnet roller is caused to exert a developing function to cause toner to adhere to the part of the photosensitive member where the potential has been lowered. In an image forming process called “transfer”, a transfer device including a transfer roller is caused to exert a transfer function to transfer the toner adhering to the photosensitive member onto a sheet.

When an image quality abnormality appears in a printed matter, it may be considered that the cause is an abnormality in the image forming function in any one of the image forming processes. For example, when a part of a member has a defect or the like, an image quality abnormality may occur in which a streak appears along a sheet feed direction of the test chart. In this case, the user can identify the image forming process that is the cause of the appearance of the image quality abnormality by comparing a plurality of test charts having different image forming conditions. In the case of the present exemplary embodiment, an existing technique can be used as a predetermined diagnosis method, such as a diagnosis method described in Japanese Unexamined Patent Application Publication No. 7-168484, for example.

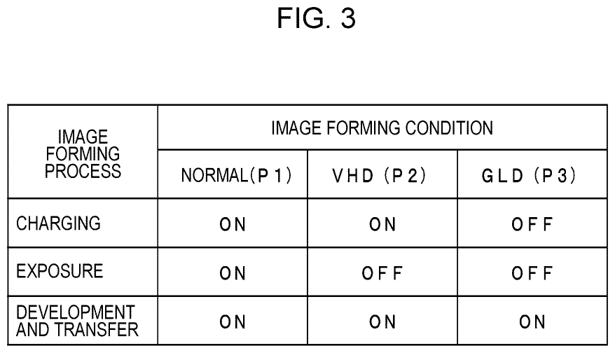

Here, while limiting the description of the diagnostic method described in Japanese Unexamined Patent Application Publication No. 7-168484 to an outline, a method for estimating the image forming process that is the cause of the appearance of an image quality abnormality using a plurality of test charts having different image forming conditions will be described with reference to a table illustrated in FIG. 3. This table may be stored in, for example, the HDD 24, or may be held inside the image forming unit 12.

In FIG. 3, the image forming processes that can be the cause of an image quality abnormality are classified into charging, exposure, and development or transfer. Since the diagnostic method described in Japanese Unexamined Patent Application Publication No. 7-168484 uses another method to distinguish between development and transfer, development and transfer are collectively illustrated in FIG. 3. The collective illustration is for the sake of convenience of description, as it is not the direct object of the present exemplary embodiment to find an image forming process that can be the cause of the image quality abnormality. In the following description, “development or transfer” is represented by development.

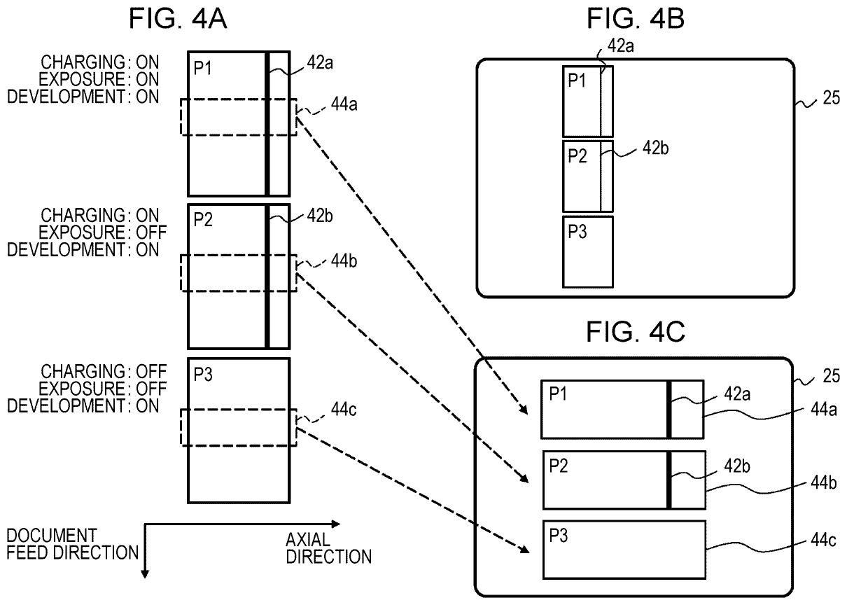

In this diagnostic method, predetermined three types of test charts for normal, VH-bias development (VHD), and GND-level bias development (GLD) are formed. In the present exemplary embodiment, since the three types of test charts are sequentially formed page by page, the types of the test charts are indicated by page numbers in FIGS. 4A to 7B, such as the first page (P1), the second page (P2), and the third page (P3), for convenience. Furthermore, in FIG. 3, whether each image forming process is caused to exert its inherent function is indicated by “ON” or “OFF”. For example, “ON” indicates that the function of the image forming process is exerted, whereas “OFF” indicates that the function of the image forming process is not exerted. Image forming conditions are set by the combination of “ON” and “OFF” of the respective image forming processes of charging, exposure, and development or transfer.

Thus, the “image forming conditions” are set according to whether or not the functions of the respective image forming processes are to be exerted. Under the normal image forming condition, an image is created using the functions of all the image forming processes. That is, as illustrated in FIG. 3, the image forming processes of charging, exposure, and development are caused to function. As illustrated in FIG. 3, a bias development image is generated according to an image forming condition different from the normal image forming condition, in other words, according to an image forming condition under which at least one image forming process is not caused to function.

First, a test chart corresponding to “Normal (P1)” (hereinafter, also simply referred to as a “normal chart”) is generated in accordance with a normal image forming process because each image forming process is “ON”. Therefore, an image quality abnormality of a streak appears in the “normal chart”. The normal chart corresponds to a “reference image” because it is generated in accordance with the normal image forming process.

In the case of the normal chart, in the image forming process of charging (hereinafter, also referred to as a “charging process”), the surface of the photosensitive member is charged using the charging device. The voltage of the photosensitive member after charging is referred to as “VH”. In the image forming process of exposure (hereinafter, also referred to as an “exposure process”), the voltage of a to-be-printed part on the surface of the photosensitive member is lowered using the exposure device. The voltage to which VH is lowered is referred to as “VL”. In the image forming process for development (hereinafter, also referred to as a “development process”), toner is caused to adhere to the surface of the photosensitive member by using the developing device. In the normal case, a potential of Vbias (VH>Vbias>VL) is applied to the magnet roller so that the toner moves from the magnet roller to the part of the photosensitive member where the voltage is lowered to VL and adheres thereto.

Subsequently, a test chart corresponding to “VHD (P2)” (hereinafter, also simply referred to as a “VHD chart”) is generated without using the exposure function because the exposure process is “OFF”. The VHD chart is generated in accordance with an image forming condition different from the normal image forming condition, and thus corresponds to a “different image forming condition image”.

In the case of the VHD chart, “Charging” is “ON” and is the same as “Normal”. Therefore, description of the charging process is omitted. The exposure process is not performed, as mentioned above. In the development process for the VHD chart, a potential Vbias (Vbias>VH) is applied to the magnet roller so that the toner moves from the magnet roller to the part of the photosensitive member where the voltage is VH and adheres thereto.

In the case of the VHD chart, since exposure is not performed, a full-page halftone test chart is supposed to be formed unless an image quality abnormality occurs. In the present exemplary embodiment, a margin is not formed on the test chart so that a white streak can be detected. The same applies to the other test charts.

Subsequently, a test chart corresponding to “GLD (P3)” (hereinafter, also simply referred to as a “GLD chart”) is generated without using the charging function and the exposure function because the charging process and the exposure process are “OFF”. The GLD chart is generated in accordance with an image forming condition different from the normal image forming condition, and thus corresponds to a “different image forming condition image”.

In the case of the GLD chart, the photosensitive member is not charged, and therefore, the potential of the photosensitive member is 0 V (GND). The exposure process is not performed, as mentioned above. In the development process in the case of the GLD chart, a potential Vbias (Vbias>GND) is applied to the magnet roller so that the toner moves from the magnet roller to the part of the photosensitive member where the potential is GND and adheres thereto.

In the case of the GLD chart, since exposure is not performed, a full-page halftone test chart is formed similarly to the case of the VHD chart, unless an image quality abnormality occurs.

Here, the image forming process causing an image quality abnormality can be identified based on the presence or absence of a streak in the above-described three types of test charts.

First, it is assumed that a streak appears in the normal chart. Here, referring to the VHD chart, if a streak that is supposed to appear in the VHD chart does not appear, it can be presumed that this is due to the absence of exposure. Therefore, the image forming process causing the image quality abnormality can be identified as the “exposure process”. Next, referring to the GLD chart, if a streak that is supposed to appear in the VHD chart appears therein and a streak that is supposed to appear in the GLD chart does not appear therein, it can be presumed that this is due to the absence of charging. Therefore, the image forming process causing the image quality abnormality can be identified as the “charging process”. Here, if the streak appears in both the VHD chart and the GLD chart, it can be identified that the image forming process causing the image quality abnormality is the “development process” or mechanical irregularities or the like on the surface of the photosensitive member.

As described above, by using the two types of test charts (corresponding to the above-described “bias development images”) of the VHD chart and the GLD chart generated according to the image forming conditions different from the case of forming the normal chart, it is possible to infer the image forming process causing the streak to appear on the test chart.

As described above, even when the appearance of a streak in the normal image is the prerequisite, it is not possible to correctly infer the image forming process causing the image quality abnormality if it is not possible to correctly determine whether a streak appears in the bias development image. Therefore, a method for inspecting the presence or absence of a streak in a bias development image according to the present exemplary embodiment will be described below with reference to a screen display example illustrated in FIGS. 4B and 4C.

FIG. 4A illustrates the above-described three types of test charts, that is, the normal chart P1, the VHD chart P2, and the GLD chart P3. Further, in FIG. 4A, the image forming conditions under which the respective patterns P1 to P3 are formed, as indicated in FIG. 3, are indicated correspondingly. In the normal chart P1, a streak 42a appears continuously along the sheet feed direction at the time of printing of the test chart. Further, a similar streak 42b also appears in the VHD chart P2. In contrast, no streak appears in the GLD chart P3. The streaks 42a and 42b are collectively referred to as a “streak 42” when they need not be distinguished from each other.

Here, when the maintenance staff confirms the presence or absence of a streak in each of the charts P1 to P3 as displayed on the operation panel 25, it is usually suitable to arrange and display all the charts P1 to P3 for easy comparison. An example of the display at this time is illustrated in FIG. 4B. However, when the entirety of all the charts is to be displayed on the operation panel 25, as illustrated in FIG. 4B, it is necessary to display the charts P1 to P3 in a reduced size due to the screen size of the operation panel 25. As a result, the streak 42 is also displayed in a reduced size, so that the thin line is displayed as a much thinner line. Then, depending on the resolution of the operation panel 25, it may become difficult for the maintenance staff to visually recognize the streak 42 even if the streak 42 appears, or the streak 42 may even be overlooked in some cases. If the presence or absence of the streak 42 is erroneously determined, the image forming process causing the image quality abnormality is erroneously inferred, as mentioned above.

Therefore, the display control unit 13 according to the present exemplary embodiment, instead of reducing each of the charts P1 to P3 in size, trims each of the charts P1 to P3, that is, cuts out a partial image from each of the charts P1 to P3 and displays the cut-out images on the operation panel 25. In the image forming process, if the sheet feed direction at the time of printing of a document is expressed as the length of the test chart and a direction orthogonal to the sheet feed direction as the width of the test chart. Then, when an image is cut out from each of the charts P1 to P3, specifically as illustrated in FIG. 4A, the entire width of the test chart is to be cut out in the direction orthogonal to the sheet feed direction, while in the sheet feed direction, an image of a part of the length of the test chart is to be cut out. Note that in the image forming apparatus 10, because the shafts of the charging roll and the like that rotate when the test charts are formed are disposed in the image forming apparatus 10 along the direction orthogonal to the sheet feed direction, the direction orthogonal to the sheet feed direction will be simply referred to as an “axial direction” in the following description.

FIG. 4C illustrates a case where parts are cut out from the respective charts P1 to P3 in the sheet feed direction and are arranged and displayed on the operation panel 25. In FIG. 4A, display areas 44a to 44c in which the partial images are cut out from the respective charts P1 to P3 and displayed are indicated by broken lines.

As described above, a partial image is cut out from each of the charts P1 to P3, and a region identifying the cut-out image is a display area on the operation panel 25. Therefore, when there is no need to distinguish the reference signs 44a to 44c from each other, the display areas are collectively referred to as a “cut-out image 44” or simply an “image 44” or a “display area 44”.

In the present exemplary embodiment, it is a prerequisite that the streak 42, when it appears in the charts P1 to P3, appears continuously along the entire length of the test chart in the sheet feed direction. Thus, with respect to the axial direction, the image 44 is cut out so as to include the entire width of the test chart. Accordingly, the image 44 cut out from the normal chart P1 in which the streak 42 appears always includes at least a part of the appearing streak 42. The normal chart P1 may have a predetermined width in the sheet feed direction. This is because the streak 42 is included in the display area 44a having the predetermined length no matter at what position and in what area (the above-described “predetermined width”) in the longitudinal direction of the normal chart P1 the display area is cut out therefrom.

In the case of the present exemplary embodiment, the images 44b and 44c may be cut out from the charts P2 and P3 in the same manner as for the normal chart P1. The position and area (the above-described “predetermined width”) of the image 44 to be cut out from the respective charts P1 to P3 along the sheet feed direction need not be particularly limited. The images 44 having different lengths (the above-described “predetermined width”) may be cut out from the respective charts P1 to P3. However, in the present exemplary embodiment, for easy comparison, the image 44 is cut out from each of the test charts P1 to P3 at the same position and in the same area (the above-described “predetermined width”).

As illustrated in FIG. 4C, according to the present exemplary embodiment, the display control unit 13 causes the images 44a to 44c respectively cut out as strips from the charts P1 to P3 to be arranged and displayed on one screen with the positions of the images 44a to 44c in the axial direction being aligned. Thus, the streak 42 appearing in the charts P1 to P3 along the sheet feed direction is easily visually recognized by the maintenance staff. If the maintenance staff can visually recognize the streak 42 appearing in the charts P1 to P3 generated by the above-described diagnostic method without overlooking, the maintenance staff can correctly infer the diagnostic result by the above-described diagnostic method, that is, the image forming process causing the streak 42 to appear in the test chart.

When the work process that is the cause of the appearance of the image quality abnormality can be identified, maintenance work is facilitated. For example, if, in view of the appearance of a streak in the VHD chart P2 and the absence of appearance of a streak in the GLD chart P3, the charging process can be identified as the cause of the appearance of the image quality abnormality as described above, it is possible to determine that the charging device used in the charging process as a member of the image forming apparatus 10 is not normal, and to narrow the maintenance target down to the charging device, or the charging roller, for example. Further, if, in view of the absence of appearance of a streak in both the charts P2 and P3, the exposure process can be identified as the cause of the appearance of the image quality abnormality as described above, it is possible to narrow the maintenance target down to the exposure device. Further, if, in view of the appearance of a streak in both the charts P2 and P3, the developing process can be identified as the cause of the appearance of the image quality abnormality as described above, it is possible to narrow the maintenance target down to, for example, the developing device, or the magnet roller, for example.

As described above, by displaying the images 44 cut out from the test charts on the operation panel 25, the maintenance staff can confirm a state in which a streak appears in the bias development images P2 and P3. Accordingly, the maintenance staff can identify the image forming process that is the cause of the appearance of the image quality abnormality, and can therefore easily identify the member to be maintained among the members constituting the image forming apparatus 10.

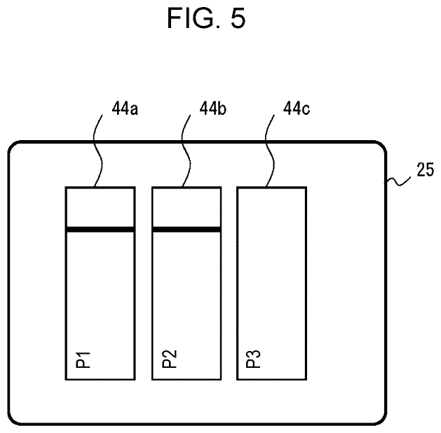

FIG. 5 illustrates another example of the screen display of the test charts in the present exemplary embodiment, corresponding to FIG. 4C. FIG. 5 illustrates a display example in which the cut-out images 44 are arranged not in the vertical direction of the screen as illustrated in FIG. 4C, but in the horizontal direction. As illustrated in FIG. 5, the images 44 may be horizontally arranged and displayed as long as they are aligned in the axial direction.

### Second Exemplary Embodiment

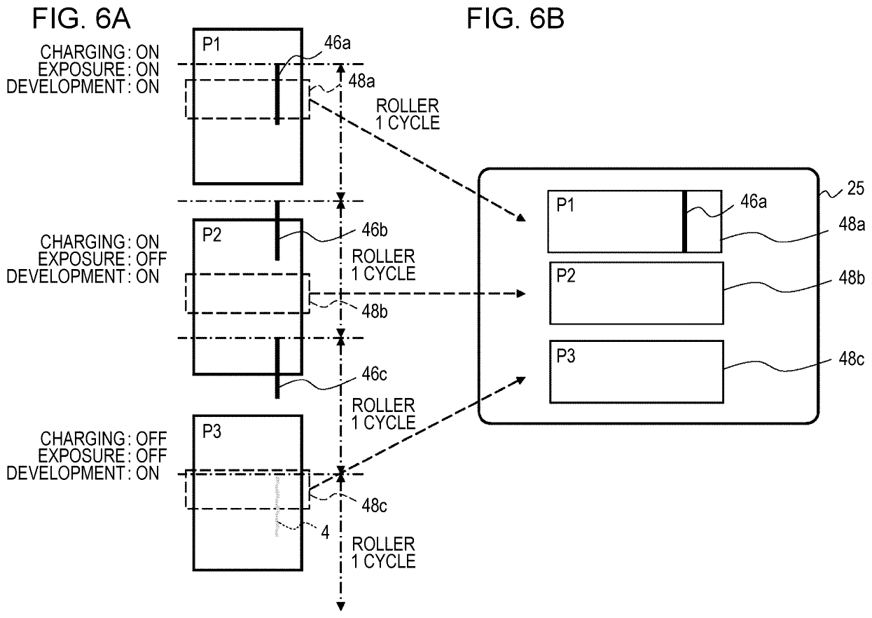

FIGS. 6A and 6B are diagrams for describing a failure that may occur when the cut-out images 44 are displayed. FIG. 6A illustrates examples of test charts to be displayed, and FIG. 6B illustrates an example of screen display of the test charts.

In the above-described first exemplary embodiment, an example has been described in which, if a streak appears in the images P1 to P3, the streak appears along the entire sheet feed direction. That is, the streak 42 appears continuously on the test chart. However, for example, if a streak appears not continuously but intermittently on the test chart, with respect to the sheet feed direction, the image forming process causing the image quality abnormality may be erroneously recognized by overlooking a streak that has actually not disappeared, depending on the cut-out position or area of the image 44.

Thus, if there is a problem only in a part in the circumferential direction of a rotating member that rotates during the operation of the image forming apparatus 10 and a streak appears on the test chart, streaks 46a to 46c appear only at positions corresponding to the rotation cycle of the rotating member, as illustrated in FIG. 6A. Therefore, depending on the cut position and area for cutting out an image 48, streaks 46b and 46c appearing in the VHD chart P2 cannot be cut out, as in an image 48b cut out from the image P2. Note that the streaks 46a, 46b, and 46c are collectively referred to as a “streak 46” when they need not be distinguished from each other. Incidentally, although no streak appears in the GLD chart P3, an image 4 is illustrated at a position where the streak, if it appears, would appear in accordance with the rotation cycle of the rotating member. In this case, referring to the images 48a, 48b, and 48c displayed on the operation panel 25, the image forming process causing the image quality abnormality is erroneously recognized.

Therefore, in the present exemplary embodiment, positions spaced apart by an integer multiple of the rotation cycle of the rotating member are set as the positions where the images 48a, 48b, and 48c are cut out.

Note that as in the case of the first exemplary embodiment, a partial image is cut out from each of the charts P1 to P3, and a region identifying the cut-out image is a display area on the operation panel 25. Therefore, when there is no need to distinguish the reference signs 48a to 48c from each other, they are collectively referred to as a “cut-out image 48” or simply an “image 48” or a “display area 48”.

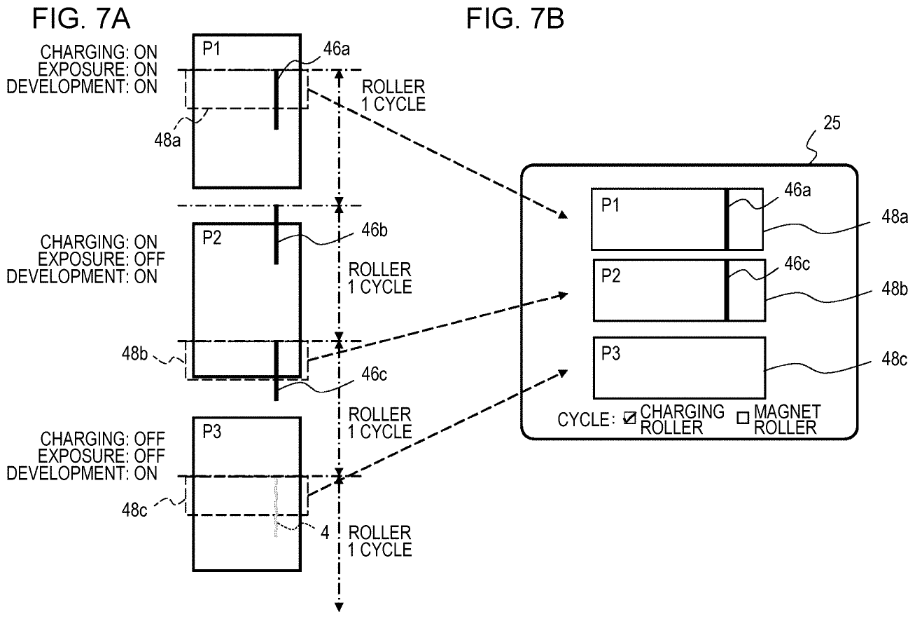

FIGS. 7A and 7B illustrate a method of setting the position of an image to be cut out in the present exemplary embodiment. FIG. 7A illustrates examples of test charts similar to FIG. 6A, and FIG. 7B illustrates a screen display example of the charts P1 to P3 in the present exemplary embodiment. As illustrated in FIG. 7A, the image 48 is cut out from the position corresponding to the rotation cycle of the rotating member. Note that the pitches at which the streak 46 appears in the charts P1 to P3 are at positions corresponding to the rotation cycle of the rotating member causing the image quality abnormality. For example, the pitches depend on specifications such as the rotation speed of the rotating member at the time of printing, the transport speed of the sheet, the printing interval of the sheets, the diameter and circumference of the rotating member, and the operation control of the rotating member. Therefore, in the present exemplary embodiment, as illustrated in FIG. 7B, the user is allowed to select the rotating member. Although the charging roller and the magnet roller are made selectable as the rotating member in FIG. 7B, any other rotating member that may cause the appearance of the streak 46 may be made selectable.

The user cannot determine which rotating member is causing an image quality abnormality. Accordingly, the user selects the rotating members sequentially from the screen illustrated in FIG. 7B, compares the display contents for the respective rotating members, and infers the rotating member causing the image quality abnormality.

When a rotating member is selected by the user, the image forming unit 12 acquires the known specifications (such as the diameter) of the selected rotating member, and, if a streak appears, calculates the cycle at which the streak appears. Then, the image 48a including the whole or at least a part of the streak 46a in the normal chart P1 in which the streak is supposed to appear without exception is cut out. When the image 48a is cut out from the normal chart P1, in the axial direction, the entire width of the test chart is cut out, as in the first exemplary embodiment. In the sheet feed direction, there is no need to provide any particular limitation as long as the streak 46a is included in the image 48a cut out from the normal chart P1. The same applies to the charts P2 and P3. Note that the present exemplary embodiment is characterized by the method of determining the positions at which the images 48b and 48c are cut out.

That is, for the charts P2 and P3, with reference to the position of the image 48a cut out from the normal chart P1, the position at which the image 48b is cut out is in an area including a position corresponding to the rotation cycle of the rotating member with respect to the position of the image 48a; i.e., an area including a position separated by an integer multiple of the rotation cycle with respect to the position of the image 48a. As in the case of the first exemplary embodiment, the display control unit 13 in the present exemplary embodiment then causes the images 48a to 48c cut out as strips from the respective charts P1 to P3 to be arranged and displayed on one screen and with the positions of the images in the axis direction aligned.

Note that in order to cut out the images 48b and 48c at the positions separated from the position of the image 48a by an integer multiple of the rotation cycle of the rotating member, the charts P1 to P3 need to be formed successively at fixed time intervals (or sheet intervals) in the image forming apparatus 10.

If the images 48a to 48c are cut out at arbitrary positions from the charts P1 to P3, the appearing streak 46 may be overlooked, as illustrated in FIG. 6B. In contrast, in the present exemplary embodiment, the images 48b and 48c are cut out at positions separated by an integer multiple of the rotation cycle of the rotating member with reference to the cut-out position of the image 48a in the normal chart P1 in which the streak 46a appears. Thus, if the streak 46 appears in the charts P2 and P3, the streak 46 can be displayed on the operation panel 25 without being overlooked.

Sets of cut-out images 48 corresponding to a plurality of rotating members selected by the user may be collectively displayed on the operation panel 25 to facilitate comparison of the images 48, as long as the images 48 can be displayed on one screen.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

### APPENDIX

(((1)))

An information processing system comprising:
a processor configured to:
   when an image quality abnormality appears in a test chart generated under a normal image forming condition along a sheet feed direction at time of printing of the test chart, acquire the test chart generated under the normal image forming condition as a reference image;
   acquire, as a different image forming condition image, a test chart generated under an image forming condition which is different from the normal image forming condition and is for allowing a user to determine an image forming process causing appearance of the image quality abnormality;
   cut out, from the reference image, an image that includes at least a part of an appearance portion of the image quality abnormality and has a predetermined width in the sheet feed direction;
   cut out, from the different image forming condition image, an image having a predetermined width in the sheet feed direction; and
   cause the images cut out from the reference image and the different image forming condition image to be arranged and displayed on one screen with positions of the images in a direction orthogonal to the sheet feed direction being aligned.
      (((2)))

The information processing system according to (((1))), wherein the processor is configured to, when the image quality abnormality appears intermittently along the sheet feed direction, cut out, from the different image forming condition image, an image at a position corresponding to a rotation cycle of a rotating member that rotates during printing of a document in an image forming apparatus that continuously forms the test charts, with respect to the position of the image cut out from the reference image.

(((3)))

The information processing system according to (((2))), wherein the processor is configured to allow the user to select the rotating member.

(((4)))

A program causing a computer to execute a process comprising:
when an image quality abnormality appears in a test chart generated under a normal image forming condition along a sheet feed direction at time of printing of a document, acquiring the test chart generated under the normal image forming condition as a reference image;
acquiring, as a different image forming condition image, a test chart generated under an image forming condition which is different from the normal image forming condition and is for allowing a user to determine an image forming process causing appearance of the image quality abnormality;
cutting out, from the reference image, an image that includes at least a part of an appearance portion of the image quality abnormality and has a predetermined width in the sheet feed direction;
cutting out, from the different image forming condition image, an image having a predetermined width in the sheet feed direction; and
causing the images cut out from the reference image and the different image forming condition image to be arranged and displayed on one screen with positions of the images in a direction orthogonal to the sheet feed direction being aligned.

What is claimed is:

1. An information processing system comprising:
a processor configured to:
when an image quality abnormality appears in a test chart generated under a normal image forming condition along a sheet feed direction at time of printing of the test chart, acquire the test chart generated under the normal image forming condition as a reference image;
acquire, as a different image forming condition image, a test chart generated under an image forming condition which is different from the normal image forming condition and is for allowing a user to determine an image forming process causing appearance of the image quality abnormality;
cut out, from the reference image, an image that includes at least a part of an appearance portion of the image quality abnormality and has a predetermined width in the sheet feed direction;
cut out, from the different image forming condition image, an image having a predetermined width in the sheet feed direction; and
cause the images cut out from the reference image and the different image forming condition image to be arranged and displayed on one screen with positions of the images in a direction orthogonal to the sheet feed direction being aligned.

2. The information processing system according to claim 1, wherein the processor is configured to, when the image quality abnormality appears intermittently along the sheet feed direction, cut out, from the different image forming condition image, an image at a position corresponding to a rotation cycle of a rotating member that rotates during printing of a document in an image forming apparatus that continuously forms the test charts, with respect to the position of the image cut out from the reference image.

3. The information processing system according to claim 2, wherein the processor is configured to allow the user to select the rotating member.

4. A non-transitory computer-readable recording medium storing a program causing a computer to execute a process comprising:
when an image quality abnormality appears in a test chart generated under a normal image forming condition along a sheet feed direction at time of printing of a document, acquiring the test chart generated under the normal image forming condition as a reference image;
acquiring, as a different image forming condition image, a test chart generated under an image forming condition which is different from the normal image forming condition and is for allowing a user to determine an image forming process causing appearance of the image quality abnormality;
cutting out, from the reference image, an image that includes at least a part of an appearance portion of the image quality abnormality and has a predetermined width in the sheet feed direction;
cutting out, from the different image forming condition image, an image having a predetermined width in the sheet feed direction; and
causing the images cut out from the reference image and the different image forming condition image to be arranged and displayed on one screen with positions of the images in a direction orthogonal to the sheet feed direction being aligned.
